(19) United States
(12) Patent Application Publication
(10) Pub. No.: US 2002/0067229 A1
(43) Pub. Date: Jun. 6, 2002

(54) Microwave window

(76) Inventor: Wilhelm Lubbers, Borger (DE)

Correspondence Address: Cesari and McKenna, LLP, 88 Black Falcon Avenue, Boston, MA, 02210, US

(21) Appl. No.: 09/991,884

(22) Filed: Nov. 23, 2001

(30) Foreign Application Priority Data
Dec. 1, 2000 (DE) 100 60 069.7

(51) Int. Cl. H01P 1/08

(52) U.S. Cl. 333/252

(57) ABSTRACT

Illustrated and described is a microwave window for the spatial separation and microwave-transmitting connection between an external microwave conductor and an internal microwave conductor or a horn radiator, with a microwave-permeable transmissive window plate and with a metal fixture for mounting said window plate.

The invention provides for the fixture to be coated with a dielectric layer and for the window plate to be fused or glued into the fixture via the dielectric layer. This results in a stress-free attachment of the window plate in the metal fixture while at the same time hermetically sealing the microwave window.

This invention relates to a microwave window for the spatial separation, with microwave transmission, between an external microwave conductor and an internal microwave conductor or horn radiator, encompassing a microwave-permeable window plate and a metal fixture for attaching the window plate. A microwave window of that type has been described for instance in DE 195 42 525 A1.

Microwave windows of the type discussed generally serve to separate a microwave generator-transmitter from a liquid or solid substance typically placed in a container. Systems of that kind are employed especially for industrial fill-level gauges operating by the radar principle. These industrial fill-level gauges usually have to meet specific requirements for the mechanical components which may come in contact with the substance in the container or the associated atmosphere. The conditions in the container concerned may involve a vacuum or very high positive pressure, an explosive atmosphere, very high or very low temperatures as well as aggressive or corrosive fluids. The microwave window serves the purpose of protecting the microwave transmitter with its sensitive electronic components from the effects of the conditions in the container filled with the substance concerned.

For the microwave window in question, a microwave-permeable window plate of a glass or ceramic material is mounted in a metal fixture into which it is either fused or sintered. The fixture for the window plate may be constituted of a component whose only purpose is to hold the window plate, but it may also be the wall of a container in which case the external microwave conductor and the internal microwave conductor are located on mutually opposite sides of that wall. This creates a pressure-resistant yet microwave-permeable separation of the two mutually opposite microwave conductors, with the window plate mounted in stress-free fashion so as not to be exposed to any forces. The window plate, fused or sintered into the fixture, thus separates the microwave transmitter system from the conditions prevailing in the container holding the substance concerned. Accordingly, aggressive and/or corrosive fluids cannot affect the microwave transmitter system.

In the process of fusing a vitreous window plate or sintering a transmissive ceramic window plate into the fixture the pressure-sealed connection between the window plate and the fixture is obtained by virtue of the fact that the window-panel material “bonds” in suitable fashion with the material of the fixture. In terms of the pressure seal, sintering provides a better “bond” than does fusing, but sintering requires markedly higher temperatures, indeed up to 80% of the melting temperature of the ceramic material of which the transmissive window plate is made.

It is therefore the objective of this invention to introduce a microwave window which permits a hermetically sealed spatial separation, with microwave connection, between an external microwave conductor and an internal microwave conductor or a horn antenna, with the window plate mounted in simple yet secure fashion.

The microwave window according to this invention, achieving the objective specified above, is based on the above-described design of a microwave window, where in this case the fixture employed is coated with a dielectric material and the window plate is fused or glued to the fixture via the said dielectric material.

As in the case of the above-referenced microwave window, the fixture may be a frame specially and exclusively serving to retain the transmissive window plate, but it may also be the wall of a container filled with the fluid. Materials suitable for microwave-permeable window plates primarily include glass or ceramic. The window plates may essentially be of any shape, although rounded and especially circular plates are preferred since they make for windows which are particularly sturdy and permit easy mounting in the fixture, merely requiring the drilling of a hole.

According to the invention, a dielectric layer is applied at least on the surface of the fixture in the area accepting the transmissive window plate. Thus, the window plate mounted in the fixture is not in direct contact with the fixture but is indirectly connected with it by way of the dielectric. The connection as such is made either by means of a separate adhesive or by fusing the window plate into the dielectric-coated opening in the fixture. Fusing-in the window plate involves the peripheral melting either of the dielectric or of the window, or simultaneously of both. The invention thus results in a microwave window whose transmissive window plate is mounted in the fixture by a simple and reliable procedure in a way as to provide a pressure seal that is essentially stress-free without any forces bearing on it.

For the purpose of this invention, the above partial coating of the fixture with a dielectric is basically all that is needed. However, in a preferred implementation of the invention the fixture is completely coated with the dielectric at least on the side facing the internal microwave conductor or horn antenna. In this context, particular preference is given to the complete coating of the fixture with the dielectric layer. If a horn antenna is located on the side of the microwave window opposite the external microwave conductor, it is entirely possible to use a horn antenna with an uncoated surface. However, according to a preferred implementation of the invention the surface of the horn antenna—and preferably all of it—is coated with a dielectric layer. Apart from the simplicity and reliability of the way in which, according to the invention, the transmissive window plate is mounted in the fixture, such coating additionally provides good corrosion protection for the fixture and the horn antenna.

The thickness of the dielectric layer on the fixture and on the horn antenna should not exceed 2 mm by much, to avoid potential charges on the dielectric that might not be in compliance with existing explosion-protection regulations. The preferred dielectric materials include such plastics as PTFE, PFA, FEP or PVDF, as well as enamel. Especially when an enamel is used as the dielectric, a stress-free mounting of the window plate in the fixture is a major advantage since one need not worry about possible spalling of the enamel layer, attributable to the window plate. After all, according to the invention the window plate is held in the fixture not by clamping or pressure-mounting but by fusion or gluing of the panel into the fixture via the dielectric, which in this case is enamel.

In a preferred design version of this invention, the microwave permeability of the microwave window can be enhanced by making the thickness of the transmissive window plate a multiple integer of the microwave wavelength. Of course, when the thickness of the window plate is adapted in that manner, the dielectric permittivity of the window material and the propagation rate of the microwave radiation within the microwave conductors must be taken into account. According to another implementation of this invention, the microwave permeability of the microwave window can be further enhanced in that, for adapting the characteristic wave impedance of the window plate to the intrinsic impedance of the microwave conductors or of the horn antenna, at least one integrated adapter is provided on the window plate. Designing the transmissive window plate and the adapter as one integrated unit eliminates any transitions between the window plate and the adapter, which avoids transition-related microwave reflections in the area of the microwave window while also eliminating any spaces between the window plate and the adapter into which aggressive and/or corrosive fluids might otherwise penetrate.

If the microwave window per this invention must withstand particularly high pressure differentials, meaning that the microwave window is exposed on one side to considerable positive or negative pressure, a preferred design version according to the invention provides for the window plate to be retained in the fixture at least in one direction perpendicular to its plane by positive-locking insertion. Such positive-locking insertion of the window plate in the fixture at least in one direction perpendicular to its plane, in conjunction with the above-described features of this invention, means that while the transmissive window plate is fused or glued into the fixture via the dielectric in a manner that it is retained in the fixture in stress-free fashion without any forces affecting it, any potential separation of the window plate from the fixture due to the prevailing high pressure differential is prevented in this design version of the invention since the positive-locking insertion of the window plate in the dielectric-coated fixture eliminates any movement of the window plate in the direction of the pressure gradient.

As a specific example, this design version of the microwave window per the invention may be implemented with a circular window plate which on the insertion side has a smaller diameter than on its opposite side. Its exposure to the higher pressure level will be on the side of the window plate that has the larger diameter. In particular, the transmissive window plate may be cone-shaped or it may have a stepped rim.

There are numerous specific ways to configure and elaborate on the design of the microwave window per this invention. In that context, the German patent application 100 60 069.7 is invoked, its substance being made a part hereof by reference. Attention is also invited to the subclaims to patent claim 1 and to the following detailed description of preferred design examples of the invention with reference to the drawings in which

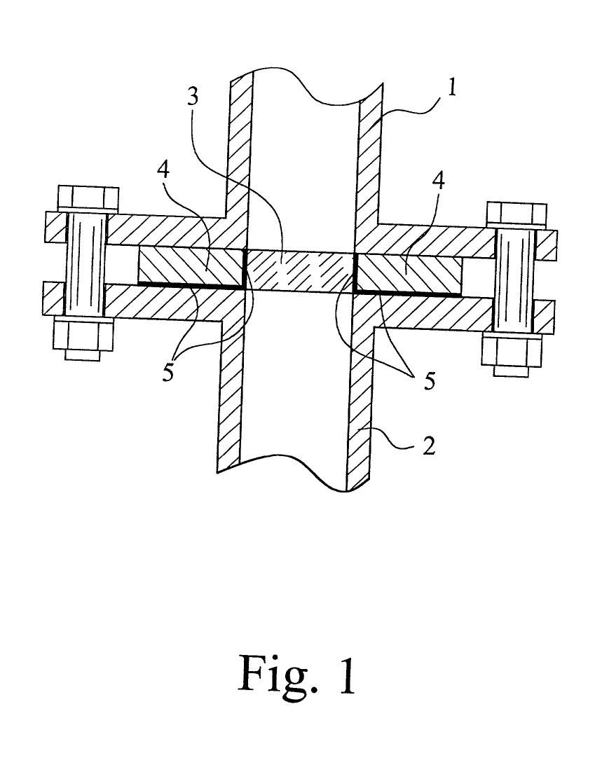

FIG. 1 is a section view of a microwave window according to a first preferred design example of the invention;

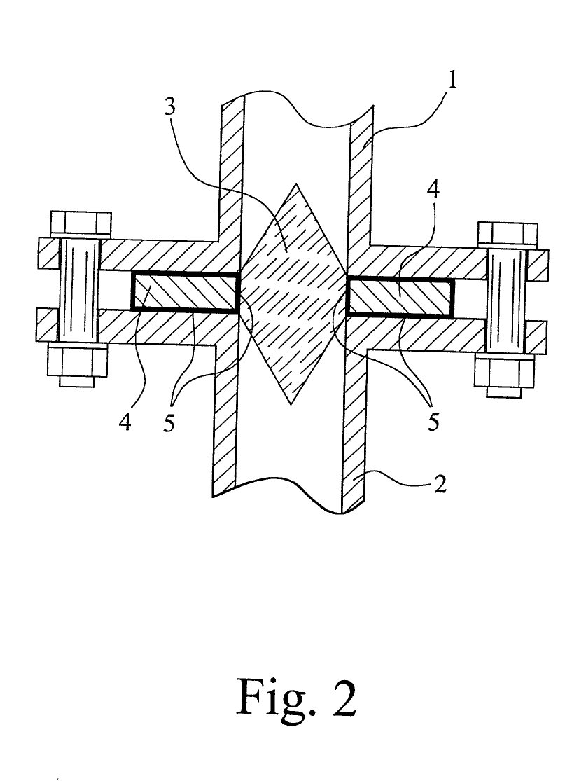

FIG. 2 is a section view of a microwave window according to a second preferred design example of the invention;

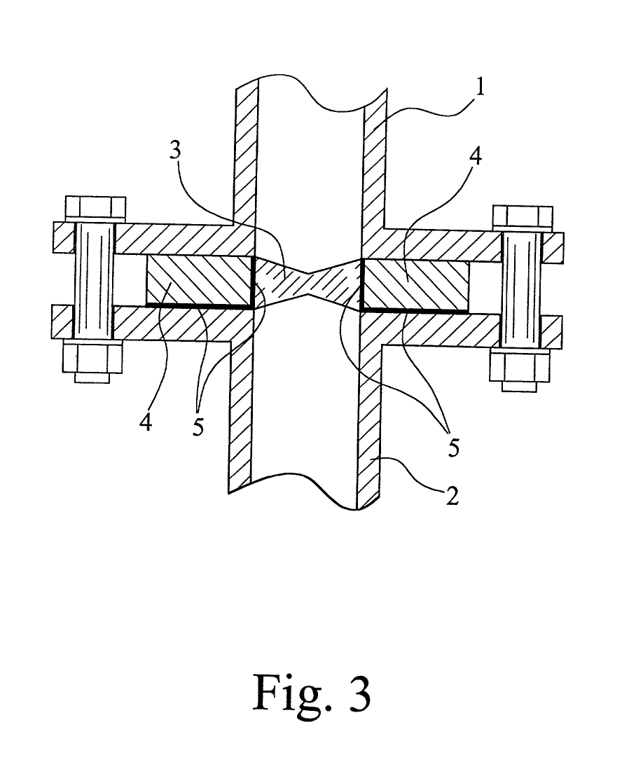

FIG. 3 is a section view of a microwave window according to a third preferred design example of the invention;

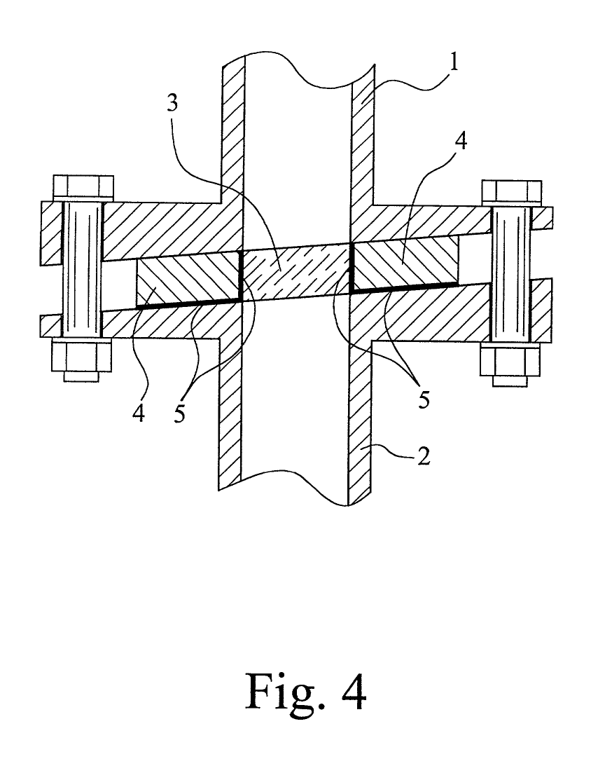

FIG. 4 is a section view of a microwave window according to a fourth preferred design example of the invention; and

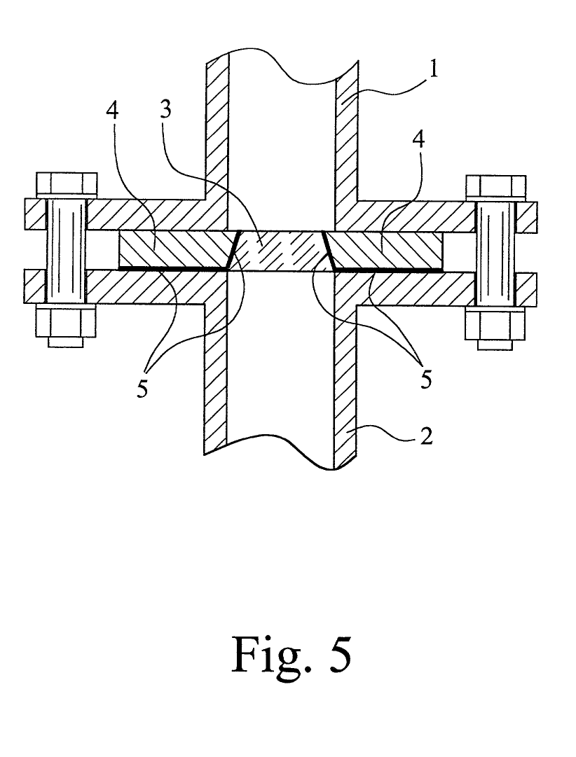

FIG. 5 is a section view of a microwave window according to a fifth preferred design example of the invention.

Illustrated in FIG. 1 is a microwave window according to a first preferred design example of the invention, serving for the spatial separation yet microwave-transmitting connection between an external microwave conductor 1 and an internal microwave conductor 2. A microwave-permeable transmissive window plate 3, made of glass, is mounted in a metal fixture 4 in combination with which it constitutes the actual microwave window. In this first preferred design example of the invention both the transmissive window plate 3 and the metal fixture 4 are round. Accordingly, for accepting the window plate 3, the fixture 4 is provided with a circular bore hole. The surface of the metal fixture 4 delineating this bore hole and the surface of the latter facing the internal microwave conductor 2 are coated with a dielectric 5 which in this case consists of an enamel layer.

In this first preferred design example of the invention, the window plate 3 is mounted in the metal fixture 4 by peripherally melting the enamel layer around the bore hole of the metal fixture 4 and inserting the window glass panel 3 in the opening with the peripherally melted enamel layer so that, after the enamel layer has cooled off, the window plate 3 is retained in the metal fixture 4 in mechanically solid fashion. This bond also provides a hermetic, and pressure-resistant, seal while at the same time ensuring a stress-free retention of the window plate 3 in the metal fixture 4. And finally, the enamel layer on the metal fixture serves as a means for protecting the metal fixture 4 against chemically aggressive and/or corrosive substances.

FIG. 2 illustrates a microwave window according to a second preferred design example of the invention. In the case of this microwave window the entire surface of the fixture 4 is covered with an enamel layer. In addition, this design employs a window glass panel 3 which is provided with an adapter, integrated into the window plate 3, both on the side facing the external microwave conductor 1 and on the side facing the internal microwave conductor 2. These adapters enhance the microwave permeability of the microwave window, since the characteristic wave impedance of the window plate 3 is adapted to the intrinsic impedance of the microwave conductors 1, 2.

In contrast to the second preferred design example of the invention, illustrated in FIG. 2, in which the microwave window features essentially conical adapters, FIG. 3 depicts a microwave window according to a third preferred design example of the invention in which the window plate 3 is provided with an essentially tapered recess both on its side facing the external microwave conductor 1 and on its side facing the internal microwave conductor 2, which recess also assists in the adaptation of the characteristic wave impedance of the window plate 3 to the intrinsic impedance of the microwave conductors 1, 2.

FIG. 4 shows a microwave window according to a fourth preferred design version of the invention in which the characteristic wave impedance of the window plate 3 is adapted to the intrinsic impedance of the microwave conductors 1, 2 by mounting the microwave window between the two microwave conductors 1, 2 not perpendicularly but at an oblique angle relative to the longitudinal axis of the microwave conductors 1, 2.

FIG. 5 finally illustrates a microwave window according to a fifth preferred design example of the invention in which the transmissive window plate 3 is retained in the fixture 4 in positive locking fashion in at least one direction along the perpendicular axis of the window plate 3. In this fifth preferred design example of the invention, the window plate 3 cannot escape upward, i.e. in the direction of the external microwave conductor 1, since the window plate 3 is cone-shaped, having a smaller diameter on its upper surface than on its lower surface. Corresponding to the shape of the window plate 3 in the case of this fifth preferred design version of the invention, the microwave window would be exposed to overpressure from below.

1. Microwave window for the spatial separation and microwave-transmitting connection between an external microwave conductor and an internal microwave conductor or a horn radiator, with a microwave-permeable transmissive window plate and with a metal fixture for mounting said window plate, in which said fixture is coated with a dielectric layer and the window plate is fused or glued into said fixture via said dielectric layer.

2. Microwave window as in claim 1, in which the fixture in its entirety is coated with the dielectric layer.

3. Microwave window as in claim 1 or 2, incorporating a horn radiator whose surface is coated with a dielectric layer.

4. Microwave window as in claim 1 or 2, in which the maximum thickness of the dielectric layer is 2 mm.

5. Microwave window as in claim 1 or 2, in which the dielectric layer consists of a plastic material and preferably PTFE, FPA, FEP or PVDF.

6. Microwave window as in claim 1 or 2, in which the dielectric layer consists of enamel.

7. Microwave window as in claim 1 or 2, in which the thickness of the transmissive window plate is a multiple integer of the wavelength of the microwaves.

8. Microwave window as in claim 1 or 2, in which, for an adaptation of the characteristic wave impedance of the window plate to the intrinsic impedance of the microwave conductors or of the horn radiator, the window plate incorporates at least one integrated adapter.

9. Microwave window as in claim 1, in which the window plate is retained in the fixture by a positive-lock configuration at least in one direction perpendicular to the axis of the window plate.

10. Microwave window as in claim 9, in which the transmissive window plate is circular in design and features a smaller diameter on its side on which it is held by positive locking than on its opposite side.

11. Microwave window as in claim 9, in which the window plate (3) is cone-shaped.

12. Microwave window as in claim 9 or 10, in which the window plate (3) features a stepped rim.
